(19) United States
(12) Patent Application Publication
(10) Pub. No.: US 2014/0261196 A1
(43) Pub. Date: Sep. 18, 2014

(54) System for Managing Livestock Flow

(71) Applicant: Prairie Systems, LLC, Spencer, IA (US)

(72) Inventor: Joel Stave, Spencer, IA (US)

(21) Appl. No.: 13/835,949

(22) Filed: Mar. 15, 2013

(51) Int. Cl. A01K 5/00

(52) U.S. Cl. CPC A01K 5/00
USPC 119/51.01

(57) ABSTRACT

A space management system for livestock producers is provided where the turn over date of the space is determined by dynamically taking into account the rate of feed intake, a starting weight, a target market weight, a feed to gain ratio and factors effecting feed intake and feed to gain ratio. The dynamic measure comprises periodic measurement of remaining feed in inventory. The system preferably includes feed inventory management capabilities that include setting a date on which to order more feed and an amount of feed necessary and, preferably, a reminder system for generating reminders to order if the order is not made. Finally, the system takes into account load out time and cleaning/preparation needed when determining a turn over date.

### FIELD OF THE INVENTION

The present invention relates generally to methods of managing livestock production and, more specifically, to managing resources such as feed, space, and turnover in a production facility that nurtures animals through several growth stages prior to selling the animals.

### BACKGROUND OF THE INVENTION

Livestock production has always been a blend of art and sciences. It requires skill and knowledge related to the animal's growth needs, feed composition necessary for each stage of growth to achieve desired output, and knowledge related to the health and well being of the animals and what to do to improve health or counter viruses or bacterial illnesses. Much of this is learned through experience. Variables effect animals in various ways and the art of animal husbandry requires knowledge about how to counter or prevent negative effects caused by such things as excessive heat on feed intake. Space and barn management, and feed and supply ordering are also critical to livestock production. The activities must be fluid and adjusted in accordance with variables as they occur or as predicted.

Producers of animals that are confined, either partially or constantly, must manage inputs carefully as well as space. Many times, producers manage a large number of buildings, perhaps located miles apart, in which animals are fed, watered, cared for and housed. Some animals are born in these confinements and then managed through several growth stages until they reach a particular market's desired characteristics and then sold. Others are purchased after birth and are managed until a desired growth stage is reached. The animals may stay in the same confinement from birth or purchase, or may be moved to another location, or a series of other locations during their lifetime. The female bearing the young may also be so moved from one location to another after giving birth, may be sold or may repeat the cycle for further gestation of additional young.

Each of the different life stages requires different feed compositions, and perhaps medicaments. Each building must be maintained and cleaned while the animals are present and between each group of animals. All of these activities require time, planning and careful management to avoid having a building sit empty (and therefore not producing) and to make sure necessary supplies and feed are delivered in a nearly just-in-time delivery mode.

A nearly just-in-time delivery mode is desirable to avoid tying up supplies and capital before needed and so large storage containers are not necessary and risks associated with storage can be avoided. In short, the logistics required to manage facilities, animal care, feed, and transportation, load out and sale dates are complex. These complexities are compounded by the variables that effect all life forms that change feed intake and/or growth. The objective of managing growth in multiple confinements is to keep all facilities filled with animals as much of the time as possible; sell animals at their appropriate growth stage and not a day later, and order feed only as necessary, but adequately, so as to avoid shortage or overage on hand.

In the past, producers managing many confinements have kept records using any one of several methods. One such method includes the use of spreadsheets relating to the number of animals, growth stage of animals, feed deliveries and schedules for the confinement, and perhaps an estimated load out date for the barn. Every day each spreadsheet could be edited to reflect the present growth status and if necessary, change the estimated load out date, however most do not consider this a worthwhile activity. Further, short of collecting data and entering it on a spreadsheet, and calculating changes, the spreadsheet does not provide a simple means to manage. Spreadsheets may include a time estimate for space clean out which would result in an expected date when the barn or confinement would be filled with a new group of animals, i.e. the “turnover date.” Some operators using spreadsheets or other methods begin the management task by estimating the number of pigs or other animals per litter and assign space based on timing of birth and the number of litters and the expected number of days to maturity. Other operators purchase young animals and house and feed them until a different growth stage is reached and predict that date based mainly on age of piglets at acquisition and days expected to mature. In either scenario, predicting a barn empty and turnover date are critical.

Part of the criticality is contributed to by the need to have another group of animals available to put into the barn, and to manage other critical aspects such as the need to alert a packer of sale of animals and to alert or contract truckers and loaders, and to order adequate (but not extra) feed for the new group of animals entering the barn.

Those employing spreadsheets typically determine predictions based on an estimated number of days to finish which estimate remains relatively static. What was needed was a far more dynamic system based on metrics other than an average growth expectation over time. What was needed was additional accuracy of predicting load out and turn over date which would, in turn, result in measurable cost savings and efficiencies related to feed ordering, and management of load out and sales.

### SUMMARY OF THE INVENTION

The present invention provides per confinement (per barn) management of space based on daily tasks, estimated budgets, and feed intake as it relates to feed to gain ratios, feed orders, feed use, and days in the confinement and comparisons of these to track a nutritional curve. The system dynamically updates the values of these factors to result in a dynamic management tool that is far more accurate related both to timing and budget requirements than estimates based on date of birth and average predicted feed intake. Specifically, the present invention employs dynamic feed intake data to regularly update the predicted time of the animal in the barn to result in a more accurate prediction of empty status. More accurate prediction of empty status provides better predictions for managing livestock sales, communicating with packers, truckers and with management of the operation. Dynamic feed intake data is used to generate recommended feed orders, reminders when orders have not been placed, budgeted turn length and current turn length. Together, these data allow the system to predict and adjust scheduled livestock sales, and estimated time for turn of the barn all of which are adjusted daily in accordance with internal algorithms keyed from feed use and normal feed to gain ratios.

### BRIEF DESCRIPTION OF THE DRAWINGS

FIG. 1—A screenshot showing the Group Flow View;

FIG. 2—A screenshot showing the Grid View.

### DETAILED DESCRIPTION OF THE PRESENT INVENTION

The present invention comprises a system for dynamically converting periodic measures of feed intake to a predicted date of sale and, eventually, date of turn of the barn. The minimum data points required for one embodiment of the invention are: Farm ID, number of animals, pounds of feed in inventory, date, standard expected feed to gain ratio, target weight of animal at sale, and an internal algorithm to compare the pounds of feed inventory on day 1 to the pounds of feed inventory at a specified point in the future (in one embodiment, that point would be the next day), divided by number of animals (preferably weighted to account for removals, dead, etc.), and to employ the standard feed to gain ratios for that animal in its particular growth stage in order to determine the number of days needed to reach the target weight at the current rate of feed intake and, consequently, predict the date of sale. Ideally, the system is provided feed inventory data at regular intervals, however, even if the feed inventory is provided on a less than regular basis, the system will provide more accurate predictions than simply using an average number of days from one stage of maturity to another.

The system of the present invention may be run via personal computer, mobile application, or a combination of the same. One embodiment comprises a hosted cloud application and can be accessed using multiple Internet browsers from a personal computer, tablet and mobile devices. Although pre-loaded with accepted standards of feed:gain ratios for various growth stages of different animals, alternatively, the operator may input feed:gain ratios, or other data that drives feed intake and/or feed to gain ratios. Further, the operator may record the exact feed composition, weather conditions, disease states, if any, and other data that may be useful in the management of the confinement in fields designated for free form data entry. The system may display data for a single confinement, for selected confinements as a whole group, or comparatively present data from different confinements to allow the operator/manager to see what, if any, differences might exist and take actions to increase the metrics of the poorer performing confinements.

The accuracy obtained by the present invention is due to its direct tie to the feed intake of the group. Feed intake will be influenced by the atmospheric temperature, by weather changes, by illnesses in the barn, by stress caused by any number of various influences. In turn, the rate of weight gain of the animals will be effected by the feed intake i.e. the ratio of feed required to gain a pound of body weight is presently thought to be relatively constant so that when feed intake is reduced, so, too, will be the number of pounds gained of body weight in a given time frame. However, schools of thought change with new research and the inventor does not wish to be bound by data relationships known today. Instead, the present invention is intended to be driven by an algorithm, or a set of algorithms that takes into account feed intake and any number of other factors, known or as yet unknown, that may affect the weight gained in accordance with a given feed intake or, on the other hand, predicts the amount of feed intake based on other known factors.

In a preferred embodiment, the feed inventory is measured daily, every other day, weekly or measured at another periodic measurement. In another preferred embodiment, the feed inventory is measured daily by an electronic scale associated with the feed bin, taking into account the weight of the bin and any loading mechanics. In a more preferred embodiment, the weight of the feed delivered to a particular confinement is measured as it passes through the angering or other transport device as it is moved from the bin to the feeders. These measurements may be recorded via an electronic scale associated with the bin and automatically updated in the system; or by a feed tube scale; or by taking into account orders, deliveries and manual bin inventories; or by any other method that can determine and provide changes from one measurement to the next of the weight and/or volume of the feed remaining. The system continually updates the expected sale date in relation to feed intake, factors affecting conversion of feed to weight, and the expected weight gain as predicted by feed intake and feed to gain ratio, taking into account additional factors that may effect the intake and gain.

Constants are taken into account by the system such as number of hours or days required to outload, and the number of days or hours to clean and ready the confinement for the next group of animals. This time is added to predict the turn over date.

In a preferred embodiment, the system may be set such that when a particular percent or amount of feed has been fed from the bin or other container, the system generates a recommendation to order feed and how much feed to order as well as determines and recommends a date of delivery and an order date on which to place an order for additional feed. The system accounts for all feed of a particular type and tracks and determines how many pounds are remaining of that type and how much to order based on the system's recommended hierarchy. Preferably, but not required, the system includes means to validate and to warn the user if the quantity the user indicates should be ordered exceeds budget, is the wrong type, conflicts with a previous order, and/or exceeds veterinary feed directive use limitations. Alternatively, the user may manually input information such as date the order is placed, the order amount and date of expected delivery. If an order is not input after the system determines one is necessary or after a date that was manually input by the user, then the system generates periodic reminders to order. The system can be set to generate such reminders daily, or every other day or at time intervals selected by the system operator.

Further, the system may be set to provide recommendations about when to schedule outload crews, trucks, contact the packer, cleaning crews, etc.

In one embodiment, the system employs the following general algorithm to transform feed intake to predicted sale date and predicted turn over date: Expected Budget Weight—G+((B/E)/D)) and Actual Animal Weight—G+(((C−F)/E)/D)

A.) Expected Daily Intake—Lbs pr Head Pr Day*Head on inventory.

### B.) Cumulative sum of Expected Daily Intake

C.) Cumulative sum of feed orders

### D.) Weighted Average Feed Conversion

E.) Weighted Animal inventory
F.) Estimated Feed on Site (order—bin inventory)
G.) Start weight of Animal

Another algorithm for obtaining the predicted sale date and predicted turn over date comprises: (Feed in pounds on day 1−Feed in pounds on day 2) divided by number of pigs consuming the feed results in pounds of feed consumed per pig per day. Multiply feed/pig/day X gain:feed ratio expected for this growth stage to obtain the number of pounds each pig is expected to gain from that feed intake that day, then determine how many days, at that rate of gain, will be necessary for the pigs to reach the target market weight. Add that number of days to today's date to obtain the sale date. Add the number of days or hours needed to clean the facility to the sale date to obtain the turn over date. Repeat this calculation daily. In other words, an algorithm that takes into account the number of pigs, their average weight, the target market weight, the total amount of feed already consumed and the expected feed:gain ratio to determine a market date will work. The algorithm should preferably determine the amount of total feed already consumed as well as the rate of feed consumed since the last purchase/delivery of feed based on any one of the measures mentioned herein or other measures that might be used to ascertain feed use. Further, the algorithm should employ feed:gain ratios expected based on conditions related, perhaps, to weather, temperature or humidity in the confinement, disease states present in the confinement, feed outages, etc., or other incidents or conditions known to effect feed intake either negatively or positively, or known to effect feed:gain ratio. The algorithm should take into account current feed amounts as well as the aforementioned factors, and the determined target market weight, to indicate when and how much feed should be ordered.

One embodiment of the present invention presents data in a visual manner using color bars spaced along a time line. For example, the user may elect to see a Grid View which shows timing of predicted sales of the entire operation, or broken out by barn, typically presented by week. In reality, barn space comes open in clusters, rather than precisely timed relative to the date the pigs enter the barn; the system is able to dynamically predict when, where, and how much space will open based on feed intake, feed:gain ratios, and other conditions for a given group of pigs, or for the operation as a whole. The preferred plot design consists of two tabs views: Group Flow and Grid View. Group Flow will display all active groups in descending order (oldest to newest). The system can provide indicators for each group regarding whether the group is on budget, the mortality rate is higher than user indicated would be acceptable, if orders should be placed, whether sales for the group should be or have been scheduled, etc. The Grid View will show animal inventory numbers categorized by type and totaled by week of the year, including expected sale date. Both views can be filtered by group status, e.g. by Owners, Health, Flow, Vendor, Branch, Farm, or Barn Type. Both views will update in accordance with data present in the system.

What is claimed is:

1. A system for dynamically converting periodic measures of feed intake to a predicted date of sale comprising periodic determination of feed intake for a given time period for a known number of a plurality of animals and employing a conversion factor for expected feed to gain ratio to predict the number of days until the average weight of said plurality of animals will reach a target sale weight.

2. The system of claim 1 wherein said periodic determination of feed intake for a given time period comprises a first feed amount recorded at a first time, a second feed amount recorded at a second time, and determining the difference between the first feed amount and said second feed amount.

3. The system of claim 1 wherein said standard expected feed to gain ratio comprises a ratio specific to any one or more conditions selected from the group consisting of: barn conditions, the growth stage of said plurality of animals, disease states, weather, feed outages.

4. The system of claim 2 wherein said number of days predicted is added to the date on which said second feed amount is recorded to provide a predicted sale date.

5. The system of claim 2 wherein said system further comprises an animal confinement in which said plurality of animals is housed and said number of days predicted to reach a target sale weight is combined with a number of days required to ready said confinement for a second plurality of animals to provide an expected turn over date.

6. The system of claim 1 wherein said periodic determination of feed intake comprises determination daily.

7. The system of claim 1 wherein said periodic determination of feed intake comprises determination at least once every three days.

8. The system of claim 2 further comprising determining the number of days remaining until said remaining feed amount is depleted.

9. The system of claim 8 further comprising means to manage feed inventory based on said number of days remaining until feed is depleted and assigning an order date on which to order additional feed.

10. The system of claim 9 wherein said system determines whether an order has been placed on said order date and generates a reminder to order if such order has not been placed.

11. The system of claim 8 wherein determining said number of days remaining until said remaining feed is depleted comprises employing at least one conversion factor relating feed to gain and accounting for effects of a known disease state on feed intake and present level of infection of said disease.

12. The system of claim 8 wherein said at least one conversion factor further accounts for expected rate of infection of said disease.

13. The system of claim 8 wherein determining said number of days remaining until said remaining feed is depleted comprises employing a conversion factor relating feed intake, said conversion factor accounting for predicted changes in barn conditions related to temperature and humidity.
